(19) United States
(12) Patent Application Publication
(10) Pub. No.: US 2023/0164115 A1
(43) Pub. Date: May 25, 2023

(54) API-BASED AD BLOCKING AND TRAFFIC MANAGEMENT

(71) Applicant: Seven Networks, LLC, Marshall, TX (US)

(72) Inventors: Sophia Glazova, Marshall, TX (US); Ari Backholm, Los Altos, CA (US); Dustin Morgan, Marshall, TX (US)

(21) Appl. No.: 18/059,616

(22) Filed: Nov. 29, 2022

Related U.S. Application Data
(63) Continuation of application No. PCT/US21/35444, filed on Jun. 2, 2021.
(60) Provisional application No. 63/080,266, filed on Sep. 18, 2020.
(60) Provisional application No. 63/034,134, filed on Jun. 3, 2020.

(51) Int. Cl. H04L 9/40; G06F 9/54; G06F 9/445

(52) U.S. Cl. CPC H04L 63/0245; G06F 9/548; G06F 9/44505

(57) ABSTRACT

Systems and methods for API-based device management for ad blocking on computing device is disclosed. API-based device management is performed using API and other method hooking within a virtual container. By directly intercepting API calls and other method calls at the application layer, no interception of network traffic is necessary, and there is no need to support network protocols at the network layer, because data can be received directly from an application. The identity of the APIs or methods to intercept and hook may be determined by analyzing a constructor or a signature in the application package.

### CROSS-REFERENCE TO RELATED APPLICATIONS

This application is a continuation application of International Patent Application No. PCT/US2021/035444 filed Jun. 2, 2021 by Seven Networks, LLC, entitled “API-BASED AD BLOCKING AND TRAFFIC MANAGEMENT,” which claims priority to U.S. Provisional Patent Application No. 63/034,134 filed on Jun. 3, 2020 by Seven Networks, LLC, entitled “API-BASED AD BLOCKING AND TRAFFIC MANAGEMENT,” and also to U.S. Provisional Patent Application No. 63/080,266 filed on Sep. 18, 2020 by Seven Networks, LLC, entitled “API-BASED AD BLOCKING AND TRAFFIC MANAGEMENT,” the entire contents of all of which are incorporated by reference herein.

### TECHNICAL FIELD

The present invention relates generally to methods and systems for providing API-based ad blocking and traffic management on a mobile device. More specifically, the present invention relates to using method hooking on a computing device to hook API calls and block ads or other malicious traffic.

### BACKGROUND

With the rise of the modern mobile devices, such as smartphones and tablets, mobile applications (or apps) have become ubiquitous. As mobile apps have become more sophisticated, so have the opportunities for unwanted material to make it onto a user's mobile device, such as ads and/or malicious traffic like spyware or malware. To combat ads and/or malicious traffic, traffic management has been used.

Device management in the context of computing devices can be thought of as monitoring and/or altering device or application behavior to improve the performance of the device or application in some way. Device management may be used, for example, for security, privacy, ad blocking, billing, usage analysis, performance analysis, policy enforcement, network optimization, device resource optimization, troubleshooting, parental controls, or other purposes. One way of performing device management is managing network traffic by analyzing the contents of incoming or outgoing network traffic and altering the traffic or the device/application behavior based on the analysis of the network traffic. Typical traffic management relies on intercepting network traffic, either on a device (e.g., computer, mobile device, etc.) or at a network component (e.g., router, bridge, switch, etc.). The intercepted network traffic may then be analyzed (referred to as deep packet inspection), and the contents of the traffic can be reverse-engineered, categorized, and/or managed as necessary to accomplish the desired device management.

Managing network traffic in network components may be problematic because multiple networks may be used by a particular device, so the traffic-management solution either must be present in each of the networks used by the device or must route the device's data through specific management points where the analysis can be performed.

Regardless of whether the network traffic management is handled in network components or in the device, each approach requires supporting various network protocols, like IP, TCP, UDP, DNS, HTTP, HTTPS, TLS, and/or application layer protocols on top of them, and/or transport/physical layer protocols beneath them.

Managing the network traffic at the device additionally requires a mechanism at the device to route traffic from apps and/or processes within the device to the traffic-management mechanism in the device. Often, in-device VPN mechanisms and/or proxy (for example, HTTP proxy) configurations route all or some of the network traffic to a local endpoint. Such mechanism may also include an HTTPS or TLS proxy to decrypt/encrypt HTTPS/TLS traffic, to allow management of the HTTP or other protocol traffic within such encrypted communications.

Accordingly, there is a need for managing functionality on a computing device to improve the device's performance or user experience without performing resource-intensive network traffic interception or other types of network traffic management at the networking layer.

### SUMMARY

The current invention provides methods, systems, and apparatus for performing device management without network traffic management or traffic interception. Such device management provides API-based management by performing API and other method hooking within a virtual container. By directly intercepting API and other calls, no traffic interception or management is necessary, and there is no need to support network protocols at the network layer, because data can be received directly from an app at the application layer.

A virtual container is implemented in a runtime on a computing device, which allows for an application to be run in an isolated environment. Within the virtual container, the methods of the application may be hooked, such that the method calls are intercepted and replacement code is executed in place of the standard code that would otherwise be executed in response to the method calls. The replacement code may be used to block websites, block networks, block or hide ads, hide or alter views, hide or alter banners, block tracking, and/or prevent other unwanted code from executing by filtering out any such unwanted elements before returning the result of the method call to the application within the virtual container.

### BRIEF DESCRIPTION OF THE DRAWINGS

FIG. 1 depicts a virtual container application running on an operating system of a computing device.

FIG. 2 depicts the runtime shown in FIG. 1, with additional detail to show hooking implemented within the virtual container in the runtime.

FIG. 3 depicts an exemplary representation of data flow with hooked code operating above the network layer.

FIG. 4A depicts the operation of an exemplary pre-hook type of hook.

FIG. 4B depicts the operation of an exemplary replace-hook type of hook.

FIG. 4C depicts the operation of an exemplary post-hook type of hook.

FIG. 5 depicts a process flow of an exemplary method of device management on a computing device.

FIG. 6 depicts a process flow of an exemplary method of device management on a computing device.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

The current invention provides methods, systems, and apparatus for performing device management without network traffic management or traffic interception. Such device management provides API-based management by performing API and other method hooking within a virtual container. By directly intercepting API and other calls, no traffic interception or management is necessary, and there is no need to support network protocols at the network layer, because data can be received directly from an app at the application layer. The API-based device management described herein may be used as an alternative to traditional network traffic interception, or it may be used in combination with traditional network traffic interception to provide additional capability.

Virtual containers may be used on computing devices to provide an emulated operating system environment to execute on the device. Applications that execute within the virtual container act as if they are being executed on an actual physical device. Virtual containers provide an isolated virtualized environment, and applications may run in the virtualized environment rather than directly on the device.

For ease of reference, the disclosure provided herein refers to the Android® operating system with mobile apps running on a mobile device; however, it will be understood by a person having skill in the art that the concepts described herein equally apply to other computing environments, operating systems, and types of devices, including non-mobile computing devices.

Referring in this case to Android®, older versions of the Android® operating system used Android's Dalvik runtime, which used a Just-in-Time (JIT) compiler. Released in 2014, Android 5.0 introduced the new ART runtime, which uses an ahead-of-time compiler. ART's ahead-of-time compilation distinguishes it as a new runtime over the Dalvik runtime. With the ART runtime's ahead-of-time compilation, an app is compiled to “quick compiled” code during installation. The “quick compiled” code consists of native processor instructions. This ahead-of-time compilation results in performance improvements because no code has to be compiled or interpreted during runtime.

The ART runtime uses direct jumps. Method calls are replaced by direct jumps to the corresponding position in memory, so method lookup is no longer needed for these calls. This is possible because boot.art is always mapped to the same location in virtual memory. When boot.art changes due to a system update, the complete byte code does not need to be recompiled, but rather the direct jumps are updated using, for example, the tool patchoat. If a method is loaded at runtime and therefore the method call cannot be converted to a direct jump, a fallback routine may be added that resolves the method call the first time it occurs.

According to the present invention, a system and method for API-based device management is provided.

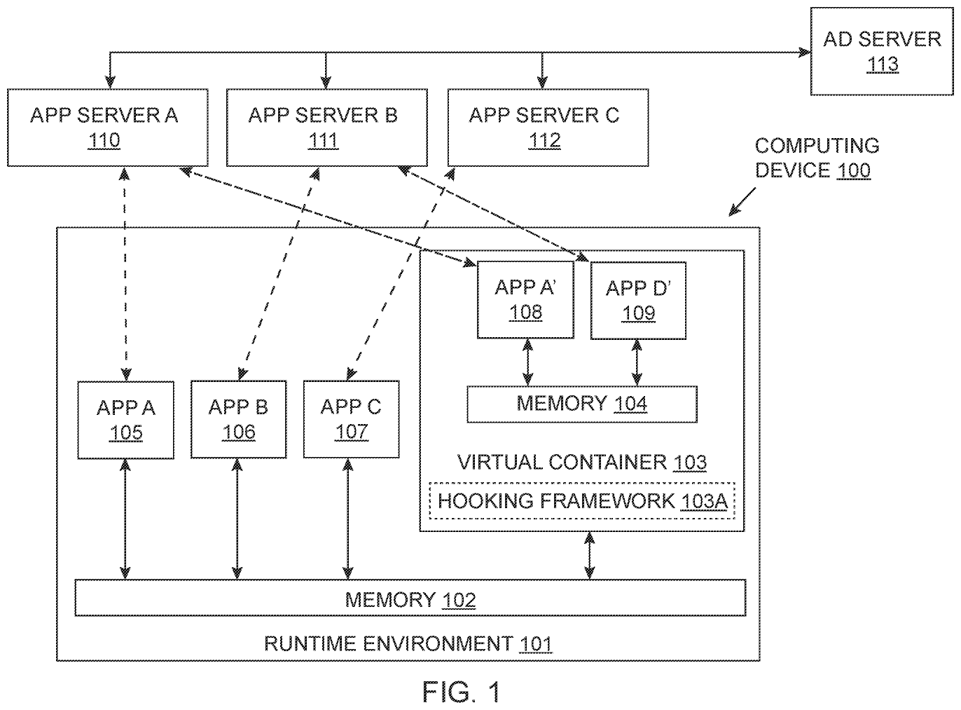

FIG. 1 depicts a virtual container application running on an operating system of a computing device.

Referring to FIG. 1, a representation of the runtime environment 101 running on computing device 100 is shown. As explained above, the embodiments described herein refer to Android®-based mobile devices, but the concepts described herein equally apply to other computing environments, operating systems, and types of devices, including non-mobile computing devices. The runtime 101 may be running, for example, on an Android®-based mobile device, such as a smartphone, tablet, or laptop computer. Within the runtime 101, there may be multiple mobile apps running. FIG. 1 shows an instance of each of App A 105, App B 106, and App C 107 running. A person having ordinary skill in the art will recognize that any number of applications may be running at any given time within the runtime 101. Additionally, the mobile device may have additional apps stored in its memory that are not currently running and are therefore not shown in the runtime 101 in FIG. 1. The apps running in the runtime 101 use memory 102 for their operation. Their compiled code for each running app, as well as the data used by the app are stored in memory 102. App A 105, App B 106, and App C 107 each communicate over a network (e.g., wireless network) with their respective App Server A 110, App Server B 111, and App Server C 112. One or more of App Servers A, B, and/or C may communicate with Ad Server 113 for serving ads into the content provided by the app servers. A person having ordinary skill in the art will recognize that there may be multiple different ad servers that one or more of the app servers receive ads or other content from.

Virtual container 103 runs as its own app in the runtime 101. The virtual container 103 app uses memory 102 to support its execution. Within virtual container 103, additional instances of an app may be run, such as App A′ 108 shown in FIG. 1. App A 105 and App A′ 108 may be different instances of the same app, such as, for example, the YouTube® app. The apps running inside the virtual container 103 may be different apps than any other apps running in the runtime 101, such as App D′ 109. Normally, only one instance of an app is run at a time within the runtime; however, the virtual container 103 allows for one instance of an app to be run outside the virtual container and another instance be run inside the virtual container (i.e., cloning). The virtual container 103 creates a virtual memory 104 for use by the apps running inside the virtual container.

The virtual container 103 in the runtime 101 may implement a framework or other mechanism 103a that enables or allows method hooking within the operating system. In the embodiments described herein that use the Android® operating system, for example, a framework such as the Xposed® framework may be implemented within the virtual container 103. In other embodiments, other frameworks or mechanisms 103a for enabling or allowing method hooking may be used. The Xposed® framework is a third-party system for Android® that allows users and/or developers to implement add-ons to the Android® operating system. The Xposed® framework allows for hooking of method calls. With the hooks that can be placed with the Xposed® framework, additional code may be injected either before or after methods. A hooking framework 103a, such as the Xposed® framework or other types of hooking frameworks, often operates on a device-wide basis. However, because, as described herein, the hooking framework 103a is implemented within the virtual container 103, it sees the entire device as just the virtual container 103, meaning that the hooking framework 103a may operate on a narrower basis, as it only operates on apps within the virtual container 103. Thus, the virtual container 103 with hooking framework 103a allows for hooking to be implemented for apps running within the virtual container 103. Hooking is used to intercept a method call at runtime to change the behavior of the calling app, which allows for the features of the app to be modified or extended. In the virtual container system disclosed herein, hooking may be used to intercept API calls or method calls to monitor the behavior of the app or to modify the function of the app (or one or more of its components). As disclosed herein, the hooks may be dynamically applied at runtime within the runtime 101. This may be accomplished by creating an in-memory copy of the called method and then modifying the in-memory copy. When the app calls the hooked method, the modified in-memory copy of the method is run, rather than the original.

In the context of Android®, the ART runtime also supports a just-in-time compiler, which may change the method entry. Java methods in the Android® operating system are represented in the virtual machine by the native method ArtMethod. The ArtMethod contains information about the method such as name, parameter types, and the entry point of the method to run the method instructions. The native ArtMethod may be replaced with a new entry as well as a trampoline to the original native ArtMethod.

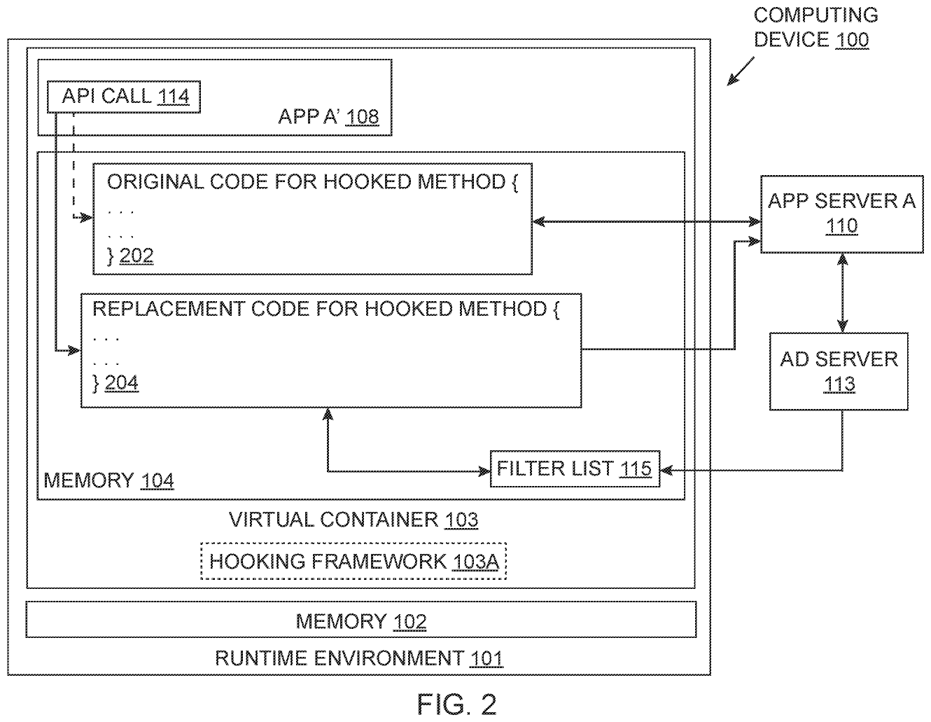

FIG. 2 depicts the runtime shown in FIG. 1, with additional detail to show hooking implemented within the virtual container in the runtime.

Referring to FIG. 2, the runtime 101 from FIG. 1 is shown with memory 102 and virtual container 103 implementing hooking framework 103a. As shown in FIG. 2, App A′ 108 is running within the virtual container 103. Because App A′ 108 is running within the virtual container 103, its code is launched and running within memory 104. In the normal, non-virtual scenario, an API call within App A would execute the original code stored in memory to make the API call. In contrast, as shown in FIG. 2, the original code 202 for the API call has been hooked and replaced with new code 204. Whereas the original code 202 would have made a call to an app server 110 and/or an ad server 113 (or other malicious server) and returned the response (including any ads or other unwanted content) to the app, the replacement code 204 for the hooked method may make the same call to the app server 110, but any response is run through a filter list 115 before being returned to the calling app to remove any unwanted content in the response, such as ads or other malware.

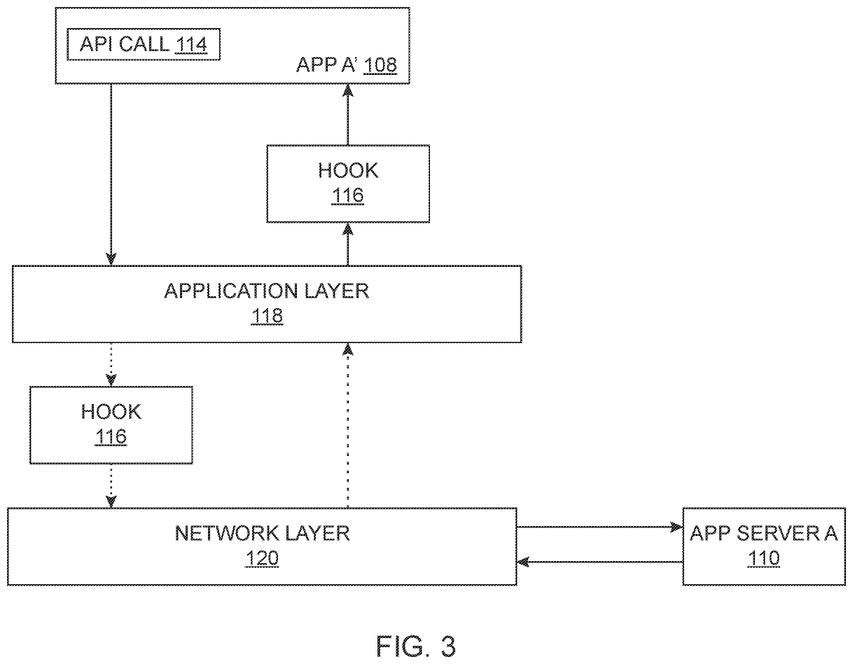

FIG. 3 depicts an exemplary representation of data flow with hooked code operating above the network layer.

Referring to FIG. 3, the hooks described herein operate above the network layer and interact with apps around the application layer. As is well understood by a person skilled in the art, communications systems are often described as operating using multiple layers, with an application layer existing at the top of a stack, and the networking layer existing at or near the bottom of a stack. Existing methods of network traffic interception and management operate at the networking layer (i.e., near the bottom of the stack) to analyze and modify data just before it is sent to a server or just after it is received from a server. When operating on data at the network layer, the networking protocols being used must be accounted for, which leads to additional processing and additional resource consumption.

In contrast, by operating on data going to or coming from App A′ 108 at the application layer 118 (i.e., near the top of the stack) using hooks 116, as shown in FIG. 3, the virtual container system described herein allows for data to be analyzed and modified by hooks 116 just after is sent from App A′ 108 or just before it is sent to App A′ 108. For example, as described herein, hooks 116 may modify raw data or URLs directly, without needing to account for networking, protocol, or the like. As can be seen in FIG. 3, hooks 116 operate above the network layer 120. The analysis and decision making at the higher layer provides for less resource consumption in the computing device.

In various embodiments, hooks 116 may comprise various different types of hooks. For example, the hooks described herein may include pre-hook types of hooks, replace-hook types of hooks, and post-hook types of hooks. These different types of hooks provide flexibility to the virtual container system described herein because in some cases, it may be easier to replace a method with some new behavior but it is more difficult to keep the existing behavior while modifying the input/output of the called method. The various types of hooks described herein allow for a method to be hooked and modified as efficiently as possible to achieve the desired result within the virtual container described herein. In various embodiments, the different types of hooks may be combined as the configuration demands. Multiple hooks and/or types of hooks may be run on the same method call in any desirable combination.

The hooks may be supported by implementing a trampoline that tells the code to jump to the section of memory that has been allocated, and that section of memory checks to determine whether the hook should be executed. If the hook should be executed, the execution jumps into a bridge method. Inside the bridge method, pre-hook callbacks that are registered for the method are executed, if they exist. Once the pre-hook callbacks are executed, then a check is performed to determine whether the method call should be skipped. If the method call should not be skipped, the registered method is retrieved and its invoke( ) call is made and the result is stored. Post-hook callbacks are then called with the result from the invoke( ) call. After all callbacks are called, the final result is returned.

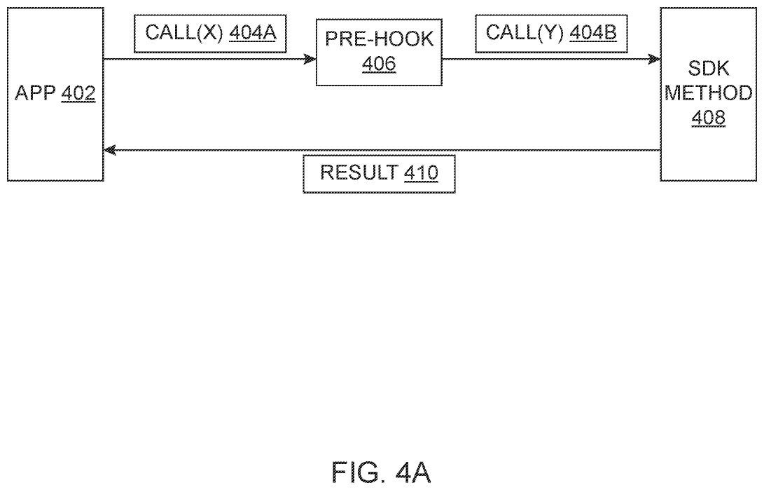

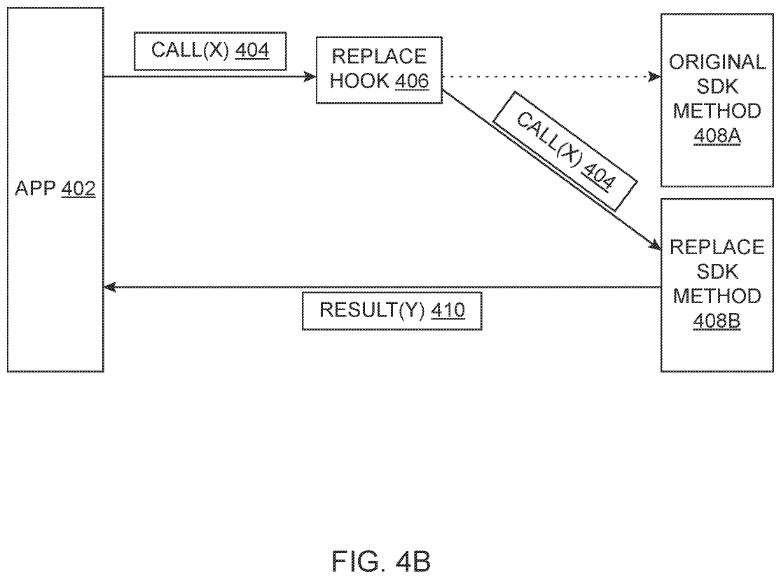

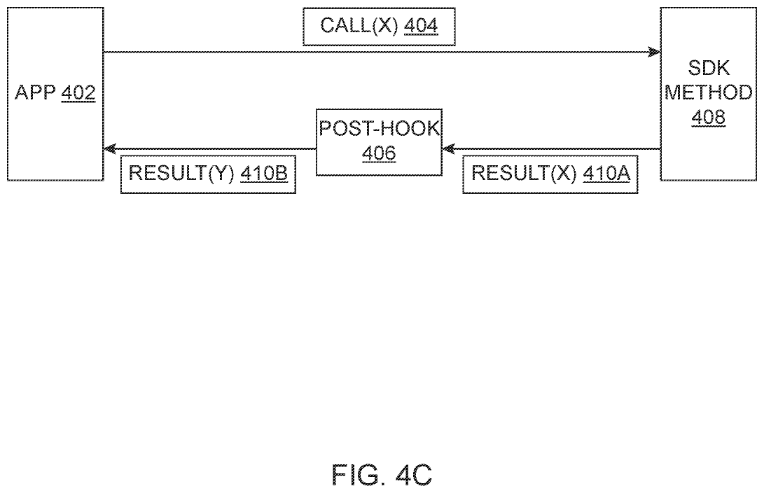

FIG. 4A depicts the operation of an exemplary pre-hook type of hook. A pre-hook controls the information that goes into the method being called. For example, the method being called may include a parameter that is passed from the application calling the method. That parameter being passed may be, for example, set to TRUE. A pre-hook allows that parameter to be changed from TRUE to FALSE so that the method being called receives the FALSE parameter and operates as if the calling application initially sent the parameter as FALSE.

Referring to FIG. 4A, app 402 calls SDK method 408 with a call having a parameter X 404A. Without the hook, SDK method 408 would be executed using parameter X 404A. In this example, however, pre-hook 406 intercepts the call having parameter X 404A and replaces the parameter X with parameter Y 404B. The SDK method 408 then runs using the call having parameter Y 404B and returns result 410 to app 402.

FIG. 4B depicts the operation of an exemplary replace-hook type of hook. A replace-hook replaces the method that was intended to be called by the application with a different method. For example, the method being called may be intended to perform an operation and return an integer value of 1. The replace-hook may replace that method with a method that does nothing but still returns the integer value of 1 to the application calling the method. The application calling the method receives the returned 1 and operates as if the called method has been performed. In a different example, rather than replacing the called method with a method that does nothing, the called method may be replaced with a method that performs the intended function of the called method but performs that intended function in a different way.

Referring to FIG. 4B, app 402 calls the original SDK method 408A using call having parameter X 404. Replace hook 406 intercepts the call having parameter X 404 and redirects it to a replacement SDK method 408B for the method being called using call having parameter X 404. The replacement SDK method 408B performs the method with the replacement code and returns result Y 410 to app 402.

FIG. 4C depicts the operation of an exemplary post-hook type of hook. A post-hook controls what the calling application receives in return from the method being called. For example, a method being called may normally return a TRUE. A post-hook allow that return value to be changed to a FALSE before it is returned to the calling application. In such a situation, from the perspective of the application calling the method, the application operates as if the method being called returned a FALSE.

Referring to FIG. 4C, app 402 calls SDK method 408 using a call having parameter X 404. The SDK method 408 performs the called function and, without the hook, would return result X 410A to app 402. However, post-hook 406 intercepts the result X 410A and replaces it with result Y 410B. The replaced result Y 410B is returned to app 402.

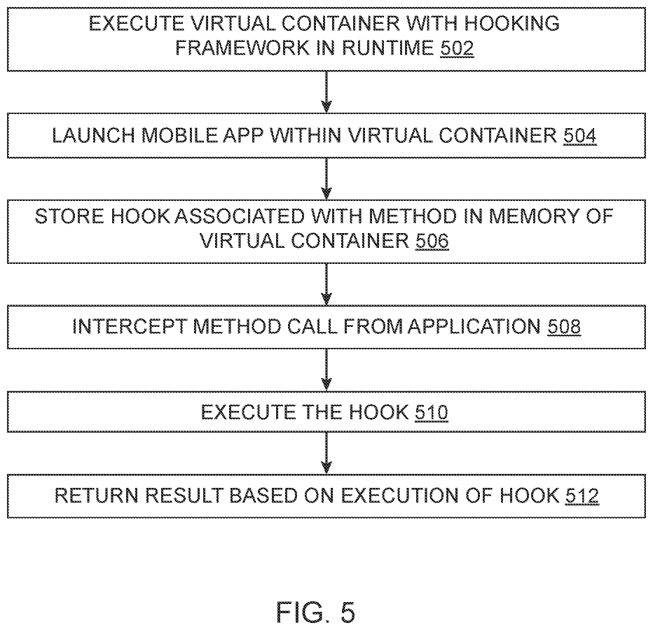

FIG. 5 depicts a process flow of an exemplary method of device management on a computing device. The device management described herein includes API-based management, in which intercept API calls are intercepted to perform ad blocking, as well blocking of other unwanted content, such as malware, spyware, tracking, or the like, and/or other device-management functions (e.g., billing, parental controls, etc.).

Referring to FIG. 5, the process of device management on a computing device includes executing a virtual container with a hooking framework or mechanism in a runtime of the device (step 502). In one embodiment, the device may be an Android®-based mobile device, such as a smartphone, tablet, or Android®-based laptop. The runtime may be the Android ART runtime.

At step 504, an application is launched within the virtual container. As explained in the context of FIG. 1, the application that is launched within the virtual container may be an instance of the same application running in the runtime but outside the virtual container (i.e., a clone). The virtual container allows for multiple copies of an application to be run on the device at the same time.

At step 506, a hook associated with a method call of the application is stored in memory of the virtual container. The hook includes software code configured to modify functionality of the associated method. In one embodiment, the hook in the memory of the virtual container may be enabled and/or created using the Xposed® framework for Android®. The hook code may be stored in memory at the location where the original code would be executed (i.e., at the address of the original code), which allows the hook code to be executed in place of the original code.

At step 508, the method call is intercepted when the application calls the method associated with the hook. The method call requests an action to be completed, such as creating a connection to a server based on a URL, or getting content from a server. The intercepted method call may be an API call, and it may be a call to an ad server or an app server.

At step 510, the hook is executed. Executing the hook may include performing at least some of the requested action of the method call. For example, if the method call is to request content from a server, the hook may be configured to request all the content and then filter the content received in response later, or the hook may be configured to request some, but not all, of the content.

In one embodiment, executing the hook may include blocking the requested action of the method call from being performed. For example, an API method call to load an ad, such as loadAd( ) may be blocked as part of the hook. In other embodiments, executing the hook may include performing the requested action such that a result from the method call is generated, and then modifying the generated result based on an implementation rule. For example, for an API method call to request content, the content may be requested and then partially filtered when received before being passed back to the calling app. The implementation rule may tell the hooked code what modifications to make and/or how to make them. For example, the implementation rule may include a filter list that specifies content to be blocked. The filter list may be maintained externally from the mobile device and periodically updated. The implementation rule may include rules relating to methods, activities, and/or banner prefixes.

At step 512, a result based on the execution of the hook is returned to the application as a response to the method call. For example, if the API call was blocked, an empty object or some data indicating that the method has been performed (even though it has not) may be returned to the calling app. If the result of the API call was modified in some way, the modified result may be returned to the calling application. If a view has been set to invisible, that result may be communicated back to the calling application.

In some embodiments, a network may be blocked by intercepting an API call to create a URL connection to a server and preventing a connection request from being transmitted to the server. In some embodiments, a URL may be blocked by intercepting an API call to create a Socket and preventing a socket connection request from being transmitted. In other embodiments, content may be blocked by intercepting an API call to retrieve the content to be viewed and setting the view to invisible for at least part of the retrieved content. In other embodiments, content may be blocked by intercepting an API call to get an object and returning an empty object in response to the API call. In other embodiments, content may be blocked by preventing intercepted methods from being loaded. In some embodiments, an app manifest is analyzed to determine an ad network used by the app, and blocking the ad network for the app in response to the determination.

There are multiple different levels or contexts in which the API-based device management system described herein may be implemented (or at any combination of the different levels). At a first level, blocking may be performed based on a host name or an IP address. At this first level, a host name or IP address may be intercepted and blocked as part of a method call for a DNS query. At a second level, blocking may be performed based on a URL. At this second level, a URL request may be intercepted and blocked as part of a method call to establish a URL connection. In traditional network traffic management, a URL may only be blocked after a connection has already been established to the destination host, which takes resources to connect to the host. In contrast, with the API interception described herein, a method call may be intercepted and acted upon when an application-level API call is made, which may occur before a network socket or other type of connection is established. At a third level, blocking may be performed based on the response content. At this third level, response content from a called method is analyzed and adjusted as necessary. The adjustment to the response content may provide direct effect, for example, if the request was for an ad or otherwise unwanted content, or indirect effect, for example, if the request was for a list of future content to show.

To block a website or network (e.g., network-based blocking), the HttpURLConnection and HttpsURLConnection classes may be hooked. For example, hooks may be made at the getInputStream( )method for the response body or at the getResponseCode( )method to alter the response code received from the server. In some scenarios, apps for some large, well-known services, such as, for example, YouTube® and Facebook®, use custom HTTP engines, so different logic may be needed to hook to their APIs, based on the specifics of the custom HTTP engines. These can be identified either through manual analysis or by analyzing their behavior at run time.

To block a URL or host, the methods for Socket creation or URL creation may be hooked to identify the URL and the content to block. The interception, in most cases, occurs outside of the networking layer.

As shown in FIG. 2, filter lists may be used (e.g., for URL and host blocking). For example, filter lists may be maintained, either internally by the system, or externally by a third-party. Such filter lists may be any combination of whitelists (i.e., lists of URLs and/or hosts to allow) and blacklists (i.e., lists of URLs and/or hosts to block). In some embodiments, the filter list may be an Adblock Plus syntax Easylist. The EasyList filter lists may be used to remove unwanted content from the internet, such as ads (for example, by removing unwanted frame, images, and objects from web pages) and/or tracking.

In the same manner as network calls, other API calls may be intercepted and hooked, which allows the system to recognize calls to unwanted or unsafe methods, such as methods for retrieving ads or spyware.

To block content (e.g., content-based blocking), methods of an SDK may be hooked. For example, Facebook® uses a loadAd( )method for banners. Thus, to block such banners, the loadAd( )method may be hooked, with the hooked loadAd( ) code being configured to locate a banner ad view and set the view to invisible, which has the effect of hiding the grey space or the ad.

As another example, Facebook® uses a listener to react with certain behavior in response to an ad being acted upon by a user (for example, clicked, viewed, or the like). The listener uses the method setAdListener( ) Thus, the setAdListener( )method may be hooked to intercept actions that are intended to occur in response to a user interacting with an ad. For example, when the setAdListener( )method is hooked, an empty new object may be returned in its place.

As another example, API-based content replacement may be used to block ads that are embedded in content from YouTube® servers for the YouTube® application. YouTube® uses objects referred to as VAST objects to show content and ads. The YouTube® server returns VAST objects in response to a method call from the YouTube® app. The API-based content replacement described herein may use hooks to intercept the response content from YouTube® servers and parse and/or analyze the content and then to alter the response so that the device does not receive pointers to ads, which prevents ads from being retrieved later.

Different apps and services use different methods, prefixes, and/or activities to trigger the various desired actions within the app. A list of methods, activities, and/or banner prefixes may be maintained to identify where and/or when to hook, as well as which views to hide in the hooked method.

Ad networks being used by an app may be detected by analyzing the app's app manifest file. An app manifest file provides information about the app, such as components of the app, which includes all activities, services, broadcast receivers, and content providers. Thus, the app manifest may be analyzed to determine which ad networks and app uses, and then specific blocking of that ad network may for that app may be enabled using hooks.

APIs and/or methods may be hooked on a per-app or per-network basis. For example, an app may offer a premium subscription, which is ad-free. In such a situation, the app may include methods or other code indicating that distinction, such as for example, when isPremium( ) returns a TRUE value, the mobile application does not include ads. Thus, the isPremium( )method may be hooked such that the ad-blocking capability is only used when the isPremium( )method returns a FALSE value. A list of such apps and their corresponding methods to hook may be maintained.

For ad network blocking, the ads may be hidden, similar to how views may be hidden. The ads may be hidden, for example, by setting the visibility to GONE, making them invisible.

Some ads are shown via BroadcastReceivers such as com.admob.android.ads.analytics.InstallReceiver. These receivers may be hooked such that they can be intercepted to either disable them entirely or return fake responses. Other ad networks may use background services that may be intercepted, such as net.youmi.android.AdService. In some ad networks, ads may be prevented from being loaded at all. For example, in AdMob, the loadAd( ) and show( )methods may be prevented from being loaded.

For activities and views blocking, ads may be hidden using their identifier, similar to a URL. These identifiers may look like com.admob.android.ads.AdMobActivity, which may be blocked directly by hiding the view. Additionally, blocking identifiers such as “*.ads.*” may be performed. In one embodiment, the virtual container system described herein may capture crashes of apps running within the container such that any crashes of legitimate apps using the blocked identifiers for non-ad purposes may be identified and remedied.

Filters may be gathered, maintained, and/or updated using community support due to the number of apps and the variation of all the uses of the apps.

Because apps and ad networks may change behavior when they are updated, rules may be used for a generic filter list to account for versions (e.g., using version codes) and application names.

In other embodiments, a community may be used to manage a generic filter list. The community input for the generic filter list grow naturally through open source and/or collaboration. In other embodiments, the user may be engaged to assist with managing a generic filter list. In still other embodiments, heuristics or machine learning may be used to dynamically determine what should be blocked/filtered.

In other embodiments, heuristics and/or machine learning may be used to manage which content is to be blocked using which API or method hooks. For example, the virtual container system described herein may receive all views at load time. Similarly, the virtual container system may have receive indicators of ad network activity at load time, so heuristics or machine learning may be applied to the views based on the indicators of ad network activity.

The virtual container system provides an option to receive reports from users of the virtual container system. In some embodiments, the option may be used to receive reports from the community, and those incoming reports may be posted to a code repository, such as, for example, GitHub, with a screenshot and some data.

The hooked code used in place of the standard code may be pre-optimized, which occurs during installation and/or update of the APK. In some embodiments, the pre-optimization may be performed all at once, rather than being batched based on “hot” or “cold” code. Once the pre-optimization has occurred, the pre-launch and launch of the application may be faster.

Speed improvements in the hooked code may be realized by syncing pre-optimized profiles based on OAT files from other users. Generally, code is the same across similar devices. Therefore, the fact that another device has already compiled hooked code into an OAT file may be used such that the compiled OAT file is uploaded from one device for use on another. Instead of optimizing packages, already-optimized profiles may be downloaded for users from a server.

Similarly, speed improvements may be achieved using an optimizer. Such an optimizer may be used outside of dex2oat, which is provided by Android, but that is faster and compatible with the ART runtime.

As explained in the context of FIG. 2, the virtual container system with hooking framework described herein may implement the Xposed® framework. Because of this, the privacy and security of users of custom modules may be addressed by allowing or disallowing certain behaviors and/or using prompts for confirmation, or the like. For example, the Xposed® framework triggers SafetyNet, which is a set of services and APIs provided as part of Android® that protects apps against security threats, including device tampering, bad URLs, potentially harmful apps, and fake users. Android® does this is because it cannot guarantee that an Xposed® module will not alter functionality of various critical apps. As a result, the virtual container system described herein may maintain a list of apps on which Xposed® modules are not allowed to operate. In other words, some apps within the virtual container system may not be allowed to be hooked within the virtual container.

In addition, for the sake of privacy, some hooks may not be supported. For example, methods that reveal personally identifiable information should be isolated.

For privacy, permissions within the virtual container system may be managed to prevent breaches in privacy. For example, if a user of the virtual container system gives an app inside the virtual container system permission to use, for example, the mobile device's camera, then other apps may be inadvertently provided access to the camera as well. The virtual container system described herein may provide fake information to apps that the user has not explicitly allowed.

The virtual container system described herein includes app lifecycle management functionality to address the numerous apps and modules running within the virtual container system at the same time. The virtual container system described herein may always run in the foreground of the operating system, which means that any applications running within the virtual container also run in the foreground of the operating system and are therefore not subject to be lifecycle managed (i.e., killed) by the operating system as part of the system management. Thus, the virtual container system described herein may be configured to implement its own lifecycle management functionality such that if multiple applications are running within the virtual container, the power usage and other parameters may be monitored and/or adjusted to ensure the virtual container remains resource efficient.

As described above, an ad blocking module may be included within the virtual container system. The ad blocking module within the virtual container system may maintain a filter list for use in the ad blocking module. That filter list may be maintained by the virtual container system, and it will be updated from time to time (e.g., periodically or upon push updates from a remote server) by the virtual container system. For example, in the situation where a server-side synchronization of the filter list occurs periodically, the virtual container system or any of its modules may facilitate this syncing.

For example, when multiple applications are opened within the virtual container system, apps that are not currently in use within the virtual container system may be closed. In some embodiments, the virtual container system described herein is configured to always remain in the foreground of the mobile device, none of the apps running within the virtual container system will be killed by the Android system, as they normally would when switching apps.

In some embodiments, the virtual container system described herein may be configured to run applications designed for different processor architectures (for example, 32-bit applications vs. 64-bit applications). This may be accomplished, for example, by using add-ons that support multiple processor architectures. For example, in the Android operating system, an “add-on” application may be used to allow support for 64-bit applications, while the main application runs as a 32-bit application. Similarly, an add-on application may be used to allow support for 32-bit applications, while the main application runs as a 64-bit application.

In the context of the virtual container system described herein, the virtual container application may run as a main application for a first processor architecture (e.g., a 32-bit application) with an add-on to allow the virtual container to add-on applications for a second processor architecture (e.g., 64-bit applications). In addition, the reverse may be true as well, with the virtual container application running as a 64-bit application (i.e., the main application) and an add-on to allow for the virtual container to run 32-bit applications. In an example where the main application is 32-bit and the add-on application is 64-bit, if a 64-bit virtual application is launched, then the 64-bit virtual application would be run from the 64-bit add-on application, whereas a 32-bit virtual application would be run from the main 32-bit application.

In embodiments of the virtual container system described herein that use Android® and the Xposed® framework, as discussed above, when a 32-bit module needs to act on a 64-bit app, an incompatibility may arise when the hook code being loaded accesses some resources (for example, a configuration file or the like) located in internal storage of an Xposed® module (for example, located at data/data/{package_name}/) because these resources would not be available. This is because virtual container system described herein may redirect the directory to a location such as, for example, data/data/com.seven.dubbl/fs/0/{package_name}, whereas the 64-bit add-on application may redirect the directory to a different location, such, for example, data/data/com.seven.dubbel.arrn64/fs/0{package_name}.

In the Android operating system, two different apps cannot access the internal files of each other. In some cases, this limitation can be avoided by using a shared user id. For example, apps such as the YouTube® app and other Google® apps (e.g., Google® GMS apps) may use a sharedUserId to share the internal files. In the virtual container system described herein, however, sharing internal files through a shared user id or other similar method may require both apps to be either 32-bit or 64-bit, which would lose the functionality of working with both 32-bit and 64-bit apps, as discussed above. To address this, the virtual container system described herein may include functionality to maintain synchronization for modules in the virtual container system across processes and apps. By keeping the modules in sync across the processes and apps, when a user creates configuration settings, for example, when launching an app in the 32-bit space of the virtual container system described herein, those same configuration settings may be observed in the 64-bit space. The sync may be performed within the virtual container system described herein by, for example, passing configuration settings in methods or storing configuration settings in internal memory.

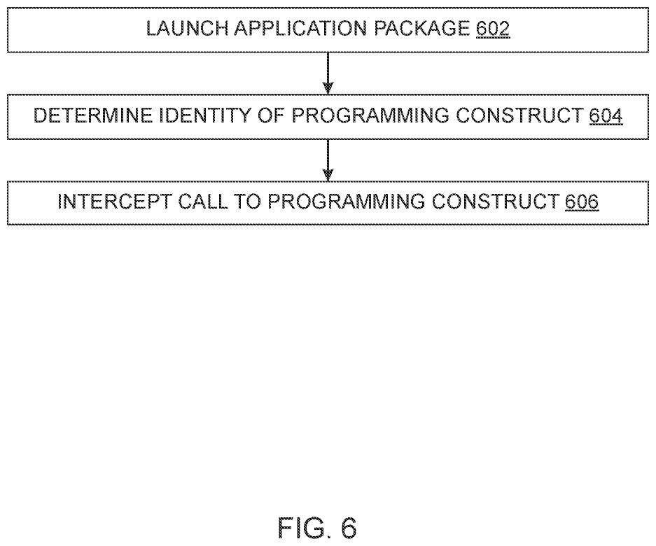

FIG. 6 depicts a process flow of an exemplary method of device management on a computing device. Referring to FIG. 6, an application package is launched on a computing device, at step 602. An application is initialized during launch of the application package. In one embodiment, the application package is launched within a virtual container executing in a runtime of the computing device, as explained above. At step 604, an identify of a programming construct is determined. In one embodiment, the programming construct may be a class constructor for an ad class object, as described in more detail below. The class constructor may include at least one parameter to modify the ad class such that ads provided by the ad class are blocked in the application. In one embodiment, the programming construct may be one that is used by the application during initialization. The identity of the programing construct is determined using any of the various methods described in more detail below. For example, as described in more detail below, the identity may be determined by analyzing a constructor signature of a call to the class constructor to find a match of the parameters of the call to the class constructor. As another example, the identity may be determined by searching for a name of the ad class. As another example, the identity may be determined by determining a list of all existing class names and checking against that list. Once the identity of the programming construct has been determined, a call to the programming construct is intercepted using the determined identity. In one embodiment, the call may be intercepted during launch of the application. In some embodiments, once the identity has been determined, it is reported to an analytics tracker such that the identity of the ad class is available to other users through a sharing mechanism, as described in more detail below.

In one embodiment, the exemplary method of device management shown in FIG. 6 further includes executing a hook for the identified programming construct to modify one or more values associated with the identified programming construct.

The exemplary methods of device management shown in FIG. 5 and FIG. 6 may be implemented by a processor on a computing device, such as, for example, a mobile device.

Identifying An Object for Hooking

As explained above, the virtual container system described herein may be used for method-based hooking or API-based hooking to modify the behavior of an application running within the virtual container. In one embodiment, the method-based hooking or API-based hooking described herein is used to block ads within an application running in the virtual container. This is accomplished by hooking the method calls or API calls for the application that has been launched within the virtual container and modifying the parameters of the application to block the ads.

A method call or an API call, or any other programming construct, such as a class, object, or the like, may be hooked when, among other things, the virtual container system has a way to identify the programming construct such that its underlying code can be hooked. As described below, one innovative aspect of this disclosure includes methods for identifying the programming construct when the name of the programming construct has been obfuscated or is otherwise unknown.

Applications that serve ads to the user handle ads using API calls, method calls, and/or program objects. For example, a new object may be created upon launch of the application, and that object communicates with an ad server or ad network, for example. The new object may be created using an API call or a method call, such as, for example, a call to a constructor for the object. For ease of reference, we refer to an object within an application that handles ads and/or the configuration of ads as an “ad class.” It is to be understood by a person having ordinary skill in the art that an “ad class” may be any type of object or other data structure (including a class) used in programming to operate as an instance of data within the program. The ad class may be any object known in traditional programming. For example, an ad class may be an object of a class type that holds ad information.

An ad class may contain ad configuration data for the ads to be displayed within the application. The ad configuration data controls settings related to the ads, such as, for example, in the context of video ads, the frequency of the video ads, the frequency of mid-roll ads; the expiration time for the ads, whether the application can show ads (e.g., block ads), and the like.

The ad class receives the initial settings on startup of the application. For example, the initial settings may indicate (1) ad blocking is disabled; (2) analytics are disabled; and (3) timeout settings are set to a default value. The application may change the settings for the ad analytics reporting and enables caching. The application may further change the ad blocking setting after initialization of the application (e.g., using API or method calls). In some situations, ad blocking settings may be set based on a build variant such that developer builds may be configured to prevent ads from showing.

The ad class may retrieve data values such as configuration parameters from a configuration file. The configuration parameters of the ad configuration data may be stored in a storage file, or they may be passed as parameters that are temporarily stored in memory. During startup of the application, the application initializes a configuration file with the default values, such as values that set default intervals for ads and that set ad blocking to FALSE. In some cases, the configuration parameters may be updated when the application synchronizes the user settings.

A class object receives its settings from the wrapper classes in the class constructor and sets them in the class variables. The purpose of the class object is to store the values and return them to the other class objects through getter functions. All values are immutable in the class and may only be modified, for example, using the class constructor during creation of the class. If the values need to be updated, then the application may generate a new class object with the updated values.

Data values for configuration parameters that provide control settings may be passed through an API call, a method call, or a class constructor call used to initialize or instantiate an ad class. In addition, the ad class may receive updates to the values from a configuration file. In one embodiment, to block ads as described herein, when the application uses the ad class, the virtual container system described herein hooks that ad class using a hooking framework as described above to return different parameter values to the application, which results in the ads being blocked.

The values returned using the hook may be fixed parameters, or they may be values that are dependent on other values. For example, the values may be returned as the original, “non-hooked” values plus a specific amount (i.e., original value+1).

Traditionally, an ad class does not allow modification of the values other than through an API call, a method call, or a class constructor call (e.g., when the ad class object is created). To address this, as explained above, the virtual container system described herein provides a way of hooking these various types of calls to modify the values.

For example, in the context of class constructor calls, the wrapper classes used in the virtual container system described herein create a new instance of the ad class that will be hooked, so that new values may be modified in the new instance of the hooked ad class. The hooking framework of the virtual container system described herein hooks the class constructor to modify the values. When the application calls the class constructor to initialize an ad class, the hook modifies the values passed into the class constructor and gives the application changed parameters. The changed parameters are set for values such as blocking ads, ad frequency, etc. in the class.

To accomplish the hooking described herein, the particular API call, method call, or class constructor call being used for the ad class object must first be identified. However, some modern applications that include ads may obfuscate the name of the ad class such that ad blocking systems cannot easily identify the ad class to modify it. Additionally, the name of the ad class may change with each version release of the application or may differ across different subsets of users (e.g., by hardware device, based on configurations, etc.) to further make it difficult to identify and modify the ad class. Similarly, some modern applications may further obfuscate the names of API calls and/or method calls.

One way to address this problem of obfuscated names is to identify the call using a signature of the call. For example, when an ad class object has an obfuscated name, the class object may be identified using a constructor signature for the ad class. For example, a class constructor for a particular class contains a specific number and type of parameters. The specific number and type of parameters may be unique to that class in that they are not found in other classes used by the application, and the knowledge of those specific numbers and types of parameters may be used to identify the ad class.

Thus, the ad class may be found by analyzing the signature of the method call when the application package is being loaded. For example, the various classes in the application package may be searched through until the class that contains a class constructor with the target signature (i.e., specific parameters) is found. After the target class constructor is found, then the class constructor may be hooked using the hooking techniques described herein, and the class parameter values are modified to block ads.

The parameters that make up a given constructor signature may be determined by checking whether the class has a declared constructor with specific parameters. For example, a determination may be made of whether the application has a class with a specific name that returns a particular object (e.g., in the case of Java, a Class.java object). The object may contain a list of constructors, fields, methods, etc., declared in the class, which can be checked for the target name. In some embodiments, the functionality used to make these determinations is included as part of the hooking framework within the virtual container system. As one example, these determinations may be made using the Xposed framework.

Once the parameters for a given class have been determined, and the class name is known, then there are multiple ways to iterate through the classes to determine the class being used for managing the ads.

Similarly, the name of a target object being searched for may be determined by looking at other aspects of the signature of the class. For example, the name of the ad class object may be determined by finding a class with a non-obfuscated name that also uses the ad class configuration, for example, the class's activities, services, application class, etc. In other words, the signature of the target object may include other functions that have non-obfuscated names that use the obfuscated class. As a result, the non-obfuscated name may be used to identify the obfuscated class name.

Another way to address the problem of obfuscated names of the ad class object is by predicting the name of the ad class object and checking those predictions against actual class names used by the application package. For example, possible class names may be generated and then checked whether that class exists in the loaded package through a brute-force method using a findClass( ) function. In another example, a list of classes may be retrieved using a class loader, and the possible class names may be checked against the list of classes retrieved using the class loader.

For example, user-defined names, such as class name, variable names, method names, and method parameter names, are obfuscated. The class name may be any random name, which may be any combination of letters, numbers, and/or symbols generated during obfuscation. In some modern applications, it has been found that a combination of letters used as a class name may be a three-letter combination. For example, the class name may be “zaq,” and further may change to a different combination of letters when the version of the application is updated.

Thus, the virtual container system described herein searches for a class with a matching signature, i.e., a target object having a signature that matches the signature that is being searched for. For example, the virtual container system may look for a class that has a class constructor that contains a specific number of parameters, with the parameters each having a certain type, and with the parameters in a specific order. For example, a particular ad class being searched for may have a class constructor signature with, for example, 17 String-type parameters, 5 Long-type values, 10 Boolean-type values, and an Integer-type value. Because it is likely that the class will not change very often since it contains basic configuration values for video ads, such as timeout, blocking ads, etc., the class may be searched for using these parameters on multiple versions.

In some cases, there may only be one class that matches or fits the signature being searched for. In such a case, it may be assumed that the class that matches or fits is the class being searched for. In other cases, however, there may be multiple classes that match or fit the same signature. In such cases, these multiple hits may be handled in different ways. In one embodiment, it may be reported back to a user that ads cannot be blocked. In such an embodiment, an error during the search may be caught and reported. In another embodiment, the matching classes having similar signatures may be further distinguished. For example, all the matching classes may be reported to an analytics tracker (e.g., Firebase). When a class is successfully found, that success may also be reported to the analytics tracker such that the class may be found the next time upon a new version of the application being released.

The ad class may be found if the system knows the ad class name, for example, by using functions that are part of the hooking framework described herein to find the classes. In this case, the virtual container system may find and hook the class's constructor if the class constructor parameters match the expected ad class parameters. The ad class may be found using a reflection search (e.g., Java Reflection) that is based on the known class name. The search works by finding the fields, constructor/method parameters, and/or classes that are extended by the known class name to find the ad class.

In a situation where the obfuscated class name is known, that class name may be searched for by checking whether the application has a class with the class name, and then hooking the class constructor for that class. In one embodiment, the search may be performed using functionality of the hooking framework described herein.

As one example, the virtual container system may find the ad class by using a call when an application package is loaded into memory. As one example, the call may be an Xposed call. Classes in the application package are searched until the class that contains a constructor with a particular constructor signature (e.g., specific parameters) is found. Once the ad class has been found, the class's constructor may be hooked and the class parameter values may be modified to block ads, using the hooking techniques described herein. In one embodiment, the Xposed functionality calls the handleLoadPackage( ) function when the app is being loaded before the application's Application onCreate( ) function is called for the loaded application.

During this call, application-specific hooks are set up for the loaded application. Each potential class name combination is looped through and checked for whether the application has a class name that matches the combination, and if the class contains the target constructor signature. Heuristics may be used to narrow, speed up, and/or optimize the search. Any hints that are known or can be derived may be used to as part of the heuristics. For example, during this search, the system may assume that the name of the obfuscated class is three letters long. After the name of the class that contains the constructor with a specific signature (e.g., particular parameters that make up the class constructor, for example) has been found, the constructor may be hooked using the methods described above.

In some embodiments, the application package either may not begin loading or may begin but not complete loading until the search has been completed, which, in some situations, may slow down the launch of the application. Thus, the speed of the search for the ad class name is an important factor in such embodiments. To address this, the search may be optimized in various different ways. For example, as explained above, some modern applications have been found to use three-letter obfuscated class names. Thus, for example, the search may be used to only look at class names that have three letters, which allows for classes with non-matching names to be skipped. Additionally, the search may be optimized based on previous search results. The previous search results may be on the same device performing the search, or on other devices where the search has already been performed and the results have been shared to other devices, or on test devices where the search has been performed in a testing environment to determine and share the search results. Thus, as an example, if it has been determined previously, either on the same device or on another device, that all the three-letter class names begin with letters toward the end of the alphabet, then the search may be performed in reverse order, starting with the last letter of the alphabet. Thus, by taking into account the previous class names, the search for future class names may be optimized such that, for example, class names beginning with letters near the end of the alphabet will be found earlier in the search, or specific letter combinations or strings are searched first regardless of alphabetical order, or wild-card searches are used with known patterns.

In some embodiments, each possible name will be checked, without regard to whether a class with that class name actually exists. In other embodiments, a list of all existing classes is first acquired, and then the list of the existing classes is searched for matches.

In one embodiment, the virtual container system does not store the ad class name after it has been found, which causes the system to search for the class name each time the application is restarted in the virtual container. This allows for the class name to be found even if the class name has changed since the last time the application was launched (i.e., if the application has been updated). In other embodiments, once the ad class name is found, the ad class name is stored such that it can be used the next time the application is launched, and assuming that the application has not been updated, the ad class name will be found quickly.

In other embodiments, the search for the ad class may be further optimized by using a reporting mechanism that allows the search of the ad class name to be determined and shared by other users of the virtual container system (e.g., a crowd-sourced solution), such that once any user of the virtual container system has found the relevant class name for a particular application, that class name is updated to all users of the virtual container system. The reporting mechanism may be configured such that the found class names may be shared with other devices either directly (i.e., from device to device) or indirectly (i.e., via one or more intermediary devices or analytics systems). In these embodiments, the crowd-sourcing of the class name may be first checked by waiting until a certain number of class names have been confirmed in multiple instances. In other words, once the same class name has been reported by a certain number of independent users of the virtual container system, the system then assumes that is the correct class name and pushes it to other users to use in their own version of the application being hooked.

Additionally, use of this reporting mechanism to determine and share the class name is advantageous in situations where the class name differs across different users of the application. For example, the class name may change upon each version update of the application. Thus, users with different versions will have different class names. Similarly, the same user will have different class names each time the application is updated (e.g., a new version). In addition, a particular class name may only apply to a particular subset of users. For example, the class name across users of an application may be different for users in different geographic regions, users having different hardware devices or device variants, and/or users having different configurations or settings of the application, or the like. This allows users of the application be provided with the class name after it has been found for a particular subset of users. For example, the class name for a new update of a particular application by the first adopters of the new update of that application may be determined and reported to other users with the same new version. Similarly, the class name for the application running on a particular hardware device may be determined and reported to other uses with the same hardware device. The same principle applies to other subgroups where the class name for the application differs based on a particular subset of users. In other words, because users update their applications at different times, only the first users of a particular version will have to determine the class name, and then later users of that particular version will be provided the determined class name for that particular version as reported by the first users.

In other embodiments, the ad class may be identified by finding another hook that uses a public API, similar to how banner ads are blocked using view blocking as described above (e.g., by hooking Android view( ) functions). As one example, a network hook may be used where an application downloads the ad settings or the ads themselves. As another example, getter methods may be hooked where the values are being returned to other classes if needed.

In one embodiment, non-video ads for YouTube®, such as banner ads and the like, may be blocked using element blocking hooks. The element blocking hooks work by finding a specific class (e.g., using the class name), and in one of the class functions checking that one of the parameters passed into the function contains a specific value that matches a search (e.g., the object's toString( ) method return string, which prints its object's values as one string). If the returned string contains the ad keyword (e.g., any string that contains “_ad_with_” to cover several different ad types), the result returned from that function is replaced and the function is prevented from further executing (e.g., the function is hooked with beforeHookedMethod( ). The function may return a custom object that contains information for the view to be displayed. The return type of the function is captured, and a new instance of the return type is created. The return type of the function may be a “base class” for the different element classes because other classes extend this class and based on class strings, there are elements such as “Slider,” “Column,” “Text,” etc. Some of the information may not be shown when checking the returned string from the object for search and carousel ads. To determine the ad type to block these ads, the data may be retrieved from another parameter of the same function that requires passing the parameter into another class, which determines the ad layout being used.

An automatic search for an element class may be used, in which another class that contains a field with an interface type that the element class extends is initially found. That class may be hooked such that at run time the class of the interface object is determined. The class of the interface object may be hooked again to find the element class to apply element blocking. The original class may be found by searching from a known class name and then searching the constructor parameters and/or fields going one or more classes deep until the class is found.

Additionally, aside from ad blocking, the virtual container system described herein may be used to modify other configuration parameters that control other aspects of the behavior of the application. The configuration parameters may be modified through API calls, method calls, or constructor calls, as described above. This may be done statically or dynamically, depending on the particular call being modified and/or the configuration parameters being modified. As one example, the other configuration parameters may relate to network calls. Such network calls may indicate, for example, which domains or hosts to use, or how often those domains or hosts are used, for example. As another example, the other configuration parameters may relate to which features are enabled/disabled for a given user. As another example, the other configuration parameters may relate to user details. As another example, the other configuration parameters may relate to items to display (e.g., via a screen) or otherwise output (e.g., play via speakers). In such situations, a decision on what to display or otherwise output may be based on numerous factors, such as, for example, the user's security clearance, security policies, corporate policies, location of the device, user preferences, administrator settings, legal requirements, family or parental control settings, contractual requirements of the user or the user's organization, the type of content, contextual parameters available to the device or a service provider, other applications that are either installed or currently running on the device, the user's approval, or the like. As another example, the other configuration parameters may relate to an environment in a game, such as other players and/or items in the field, properties and/or actions available for a given item, whether it is a game characters, etc. As another example, the other configuration parameters may relate to the type of information entry, such as email, calendar, or contacts, for example.

Thus, as described herein, in one embodiment, a method of device management on a computing device is disclosed. The method includes launching an application package on the computing device, with the application being initialized during launch of the application package. Upon launch of the application package, an identity of a programming construct used by the application is determined during initialization. The identity of the programming construct may be determined by analyzing a signature of the programming construct. Using the determined identity of the programming construct, a call to the programming construct is intercepted during launch of the application. The application package may be launched within a virtual container executing in a runtime of the computing device. A hook for the identified programming construct may be executed to modify one or more values associated with the identified programming construct. The programming construct may be a class constructor for an ad class object. The class constructor may include at least one parameter to modify the ad class such that ads provided by the ad class are blocked in the application. The identity of the ad class may be determined by analyzing a constructor signature of a call to the class constructor to find a match of the parameters of the call to the class constructor. The identity of the ad class is determined by searching for a name of the ad class. Searching for the name of the ad class may include a brute-force check of each possible name of the ad class until a match is found. The brute-force check of each possible name may be performed using heuristics for optimization. The searching for the name of the ad class may include determining a list of all existing class names and checking against said list of existing class names. Once the identity of the ad class has been determined, the identity of the ad class may be reported to an analytics tracker such that the identity of the ad class is available to other users through a sharing mechanism. The virtual container may execute in the Android® operating system. The computing device may be an Android®-based mobile device. The hook may be enabled using the Xposed® framework for Android®. The methods described herein may be implemented on a mobile device having a processor configured to execute the methods.

As described herein, in another embodiment, a method of device management on a computing device is disclosed. The method includes executing a virtual container in a runtime of the computing device. The method further includes launching an application within the virtual container. The method further includes storing a hook associated with a method call of the application in a memory of the virtual container. The method further includes intercepting the method call when the application calls the method associated with the hook. The method call requests an action to be completed. The method further includes executing the hook. The method further includes returning a result based on the execution of the hook to the application as a response to the method call. The hook may include software code configured to modify functionality of the associated method. Executing the hook may include performing at least some of the requested action of the method call. Executing the hook may include blocking the requested action of the method call from being performed. Executing the hook may include performing the requested action such that a result from the method call is generated, and modifying the generated result based on an implementation rule. The implementation rule may include a filter list that specifies content to be blocked. The filter list may be maintained externally from the computing device and periodically updated. The device management may include ad blocking. The runtime may be an Android ART runtime. The intercepted method call may be an API call. The computing device may be an Android-based mobile device. The application launched within the virtual container may be an instance of the same application running in the runtime but outside the virtual container. The intercepted method call may include a call to an ad server. The intercepted method call may include a call to an application server. The hook in the memory of the virtual container may be enabled using the Xposed® framework for Android®. A network may be blocked by intercepting an API call to create a URL connection to a server and preventing a connection request from being transmitted to the server. A URL may be blocked by intercepting an API call to create a Socket and preventing a socket connection request from being transmitted. Content may be blocked by intercepting an API call to retrieve the content to be viewed and setting a view to invisible for at least part of the retrieved content. Content may be blocked by intercepting an API call to get an object and returning an empty object in response to the API call. Content may be blocked by preventing intercepted methods from being loaded. The implementation rule may include at least one of methods, activities, and banner prefixes. An app manifest may be analyzed to determine an ad network used by the application, and blocking the ad network for the application in response to the determination. The methods described herein may be implemented on a mobile device having a processor configured to execute the methods.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby®, JavaScript®, Java®, Python®, PHP, C, C++, C#, Objective-C®, Go®, Scala®, Swift®, Kotlin®, OCaml®, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention described herein make reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-37. (canceled)

38. A computing device for performing device management, the computing device comprising:
a hardware processor, the hardware processor configured for:
launching an application package within a virtual container executing in a runtime of the computing device, wherein an application is initialized during launch of the application package;
upon launch of the application package, determining an identity of a programming construct used by the application during initialization; and
intercepting, using the determined identity of the programming construct, a call to the programming construct during launch of the application.

39. The computing device of claim 38, wherein the identity of the programming construct is determined by analyzing a signature of the programming construct.

40. The computing device of claim 38, wherein the computing device is an Android®-based mobile device and the virtual container executes in the Android® operating system.

41. The computing device of claim 38, wherein the hardware processor is further configured for executing a hook for the identified programming construct to modify one or more values associated with the identified programming construct.

42. The computing device of claim 41, wherein the hook is enabled using the Xposed® framework for Android®.

43. The computing device of claim 38, wherein the programming construct is a class constructor for an ad class object.

44. The computing device of claim 43, wherein the class constructor includes at least one parameter to modify the ad class such that ads provided by the ad class are blocked in the application.

45. The computing device of claim 43, wherein the identity of the ad class is determined by analyzing a constructor signature of a call to the class constructor to find a match of parameters of the call to the class constructor.

46. The computing device of claim 43, wherein the identity of the ad class is determined by searching for a name of the ad class.

47. The computing device of claim 46, wherein searching for the name of the ad class includes a brute-force check of each possible name of the ad class until a match is found, wherein the brute-force check of each possible name is performed using heuristics for optimization.

48. The computing device of claim 46, wherein searching for the name of the ad class includes determining a list of all existing class names and checking against said list of existing class names.

49. The computing device of claim 46, wherein once the identity of the ad class has been determined, the identity of the ad class is reported to an analytics tracker such that the identity of the ad class is available to other users through a sharing mechanism.

50. A method of performing device management on a computing device, the method comprising:
launching an application package within a virtual container executing in a runtime of the computing device, wherein an application is initialized during launch of the application package;
upon launch of the application package, determining an identity of a programming construct used by the application during initialization; and
intercepting, using the determined identity of the programming construct, a call to the programming construct during launch of the application.

51. The method of claim 50, wherein the identity of the programming construct is determined by analyzing a signature of the programming construct.

52. The method of claim 50, further comprising executing a hook for the identified programming construct to modify one or more values associated with the identified programming construct.

53. The method of claim 50, wherein the programming construct is a class constructor for an ad class object, and wherein the class constructor includes at least one parameter to modify the ad class such that ads provided by the ad class are blocked in the application.

54. The method of claim 53, wherein the identity of the ad class is determined by analyzing a constructor signature of a call to the class constructor to find a match of parameters of the call to the class constructor.

55. The method of claim 53, wherein the identity of the ad class is determined by searching for a name of the ad class.

56. The method of claim 55, wherein searching for the name of the ad class includes a brute-force check of each possible name of the ad class until a match is found, wherein the brute-force check of each possible name is performed using heuristics for optimization.

57. The method of claim 55, wherein once the identity of the ad class has been determined, the identity of the ad class is reported to an analytics tracker such that the identity of the ad class is available to other users through a sharing mechanism.
